(19) United States
(12) Patent Application Publication
(10) Pub. No.: US 2026/0116796 A1
(43) Pub. Date: Apr. 30, 2026

(54) METHOD FOR RAPIDLY STARTING DYE-ORGANIC WASTEWATER ANAEROBIC CO-METABOLIC SYSTEM BASED ON S-NZVI

(71) Applicant: Nanjing University, Nanjing (CN)

(72) Inventors: Ming HUA, Nanjing (CN); Linxuan CHE, Nanjing (CN); Ziruo WANG, Nanjing (CN); Weiming ZHANG, Nanjing (CN); Bingcai PAN, Nanjing (CN)

(73) Assignee: Nanjing University, Nanjing (CN)

(21) Appl. No.: 19/369,328

(22) Filed: Oct. 27, 2025

(30) Foreign Application Priority Data
Oct. 29, 2024 (CN) 202411515686.8

(51) Int. Cl. C02F 3/28; C02F 11/04; C02F 11/143; C02F 101/30

(52) U.S. Cl. CPC C02F 3/28; C02F 11/04; C02F 11/143; C02F 2101/308; C02F 2209/06

(57) ABSTRACT

A method for rapidly starting a dye-organic wastewater anaerobic co-metabolic system based on S-nZVI comprises the following steps: S1, preparation of S-nZVI and S2, anaerobic treatment of S-nZVI optimized dye-organic wastewater. According to the present disclosure, sulfur-doped nano iron is first applied to the dye-organic wastewater anaerobic co-metabolic system, so that by sulfur doping, the dispersibility of nano iron is improved; by sulfur doping, a hydrogen evolution reaction is inhibited and the reductive damage of a cell membrane is avoided; meanwhile, the formation of FeS endows nano iron with stronger electrical conductivity, which is conducive to enriching electron transfer pathways of microorganisms and improves the transfer efficiency of electrons.

The present application claims the priority of Chinese patent application No. 202411515686.8, filed 2024 Oct. 29, the entire disclosure of which Chinese application is incorporated herein by reference.

### TECHNICAL FIELD

The present disclosure belongs to the technical field of water pollution control, and particularly relates to a method for rapidly starting a dye-organic wastewater anaerobic co-metabolic system based on S-nZVI.

### BACKGROUND

Industries such as textiles, printing and dyeing and papermaking generate large amounts of dye wastewater, accounting for approximately 20% of total global industrial wastewater. Among them, azo dyes account for 60-70% of the total synthetic dyes and are one of the characteristic pollutants that must be focused on in dye wastewater. If not improperly treated, the dye wastewater may cause serious environmental problems and endanger human health. Currently, the main treatment technologies for azo dyes include a physical method, a chemical method, a biological method, and their combined processes. Anaerobic treatment is a green and economical pretreatment process. In the anaerobic treatment, the biodegradability of refractory wastewater is enhanced by converting macromolecular organic matters. In this process, azo dyes are converted into aromatic amines which are easily degraded by microorganisms under aerobic conditions.

However, satisfactory effects have not yet been achieved in the anaerobic treatment of dye wastewater for the reasons that first, azo dyes have large molecular weights and strong polarity, and difficultly enter microbial cells to be degraded by microorganisms; second, as typical wastewater with a low carbon-to-nitrogen ratio, insufficient electron donor sources and the competitive effect of other electron acceptors lead to insufficient bio-degradation efficiency of azo dyes. Therefore, dye wastewater is typically co-metabolized with high-organic wastewater, thereby providing sufficient electron sources for dye degradation. Conversely, the inhibitory effect of such the co-metabolic method on anaerobic digestion is usually worth paying attentions. Due to the biological toxicity of azo dyes and their reduction products aromatic amines, the activities of acid-producing and methane-producing microorganisms tend to become imbalanced, leading to adverse syntrophic metabolism and poor system stability. It has been reported that compared with acid-producing bacteria, methanogenic bacteria are more sensitive to adverse environments. This leads to the continuous accumulation of volatile fatty acids (VFAs) (mainly including acetic acid, propionic acid and butyric acid) due to hindered conversion in the anaerobic digestion process, resulting in start-up failure or collapse of a reactor due to excessive acidification during the operation. Therefore, successfully starting up the reactor from potential failures and maintaining the stability of the co-metabolic system not only ensure the efficient degradation of dyes, but also achieve the efficient recovery of energy, which undoubtedly has important practical significance.

In recent years, nano iron materials have been applied to an anaerobic digestion system. Due to its strong reducibility and electrical conductivity, nano iron can serve as an electron donor for CO₂ reduction and enrich hydrogenotrophic methanogens, thereby reducing the hydrogen partial pressure in the anaerobic digestion process. This indirectly leads to easier conversion of VFAs in terms of thermodynamics. On the other hand, numerous studies have reported that conductor or semi-conductor materials can enhance the extracellular electron transfer (EET) of microorganisms. Therefore, the extracellular degradation of azo dyes may be enhanced, which not only saves the energy consumed for transmembrane entry into cells and improves the transfer efficiency of electrons, but also alleviates the toxic effect of azo dyes entering the cells on anaerobic microorganisms. In addition, methanogenic bacteria may use extracellular electrons to establish an interspecific direct electron transfer (DIET) mechanism. DIET enables electron transfer between microorganisms through conductive pili or cytochrome C, and this syntrophic metabolism is more advantageous than interspecific hydrogen transfer (IHT) in terms of energy utilization methods. Therefore, even under the adverse conditions (dye stress) or high concentrations of VFAs, thermodynamic bottlenecks in the syntrophic metabolism process can be overcome; furthermore, through a direct interspecies electron transfer (DIET) pathway which is more energetically favorable, VFAs can be degraded and methane can be produced. It is worth mentioning that the establishment of DIET is not only beneficial for CO₂ reduction, but also can enhance the aceticlastic methanogenesis. However, affected by surface forces such as van der Waals forces and magnetic forces, nano iron is easy to agglomerate, resulting in a decrease in its reaction activity. Meanwhile, lots of studies have reported that the effect of nano iron on microorganisms is dose-dependent. This is mainly because of strong reducibility of nano iron: on the one hand, it causes reductive damage of microbial cell membranes; on the other hand, in an aqueous medium, nano iron easily undergoes a hydrogen evolution reaction with protons, so that excessively high hydrogen partial pressure not only leads to electron wastes, but also affects thermodynamic balance in the anaerobic digestion process.

Sulfur doping technologies provide an opportunity to address the aforementioned shortcomings in the application of nano iron. By introducing vulcanization reagents in the preparation process of nano iron, FeS is formed as a framework, which can effectively improve the dispersibility of nano iron particles. FeS has a certain degree of hydrophobicity, which is conducive to regulating the hydrogen evolution reaction of nano iron, thereby avoiding the excessively high hydrogen partial pressure. In addition, FeS has excellent electrical conductivity and can serve as an active site of nano iron, thereby alleviating the reductive damage to microbial cell membranes while improving the electrical conductivity of nano iron. Therefore, we hypothesize that in the co-metabolic system of dye wastewater and organic wastewater, sulfur doping will enhance the improvement efficacy of nano iron in anaerobic digestion in terms of thermodynamics and kinetics, provide a more suitable environmental condition for microorganisms, and meanwhile further optimize a proton-electron transfer network and a microbial community structure during the pollutant degradation and methanogenesis. Therefore, an energy-saving, efficient and stable anaerobic metabolic system is conducted.

### SUMMARY

To solve the above problems, the present disclosure provides a method for rapidly starting a dye-organic wastewater anaerobic co-metabolic system based on S-nZVI.

The technical solution of the present disclosure is as follows: provided is a method for rapidly starting a dye-organic wastewater anaerobic co-metabolic system based on S-nZVI, comprising the following steps:
S1, preparation of S-nZVI
in an inert atmosphere, dissolving sodium dithionite and 0.1-0.15 mol/L ferrous sulfate heptahydrate in ultrapure water in a molar ratio of S:Fe=(0.1-0.5):1, stirring and evenly mixing to obtain a mixed solution, then dropwise adding 0.4-0.5 mol/L potassium borohydride into the mixed solution at an addition rate of 8-12 mL/min by using a peristaltic pump for 18-22 min, and then removing supernatant followed by centrifuging and washing the obtained product with ultrapure water and ethanol in sequence, and subsequently drying the washed product in vacuum to obtain sulfur-doped nano iron particles marked as S-nZVI; and
S2, anaerobic treatment of S-nZVI optimized dye-organic wastewater
adding anaerobically digested sludge into a serum bottle and allowing the concentration of the anaerobically digested sludge to 4-6 gTS/L, then adding the S-nZVI obtained step S1 into the anaerobically digested sludge in an addition amount of 0.4-0.6 g/L, introducing 120-180 mL of dye-organic wastewater into the sludge, adjusting the pH of the sludge to 6.8-7.2 by using a pH adjuster, and then putting the sludge subjected to nitrogen stripping for 25-35 min onto a shaker for 10-14 h of anaerobic biological treatment; wherein the pH adjuster is a 0.1 mol/L HCl solution or a 0.1 mol/L NaOH solution, and the above addition amount of S-nZVI has a better ability of enriching functional microorganism and providing exogenous electrons, thereby efficiently converting VFAs into methane under the adverse condition of dye stress.

Further, in step S1, the purity of the inert gas is 99-99.9%, the stirring speed is 180-220 rpm, and the stirring time is 25-40 min;

it indicates that the S-nZVI prepared by using the above parameters has better performance and can effectively improve the dispersion effect of nano iron, thereby inhibiting the hydrogen evolution reaction, and further preventing the nano iron from being damaged to optimize the performance of the nano iron.

Further, the vacuum drying method is as follows: the washed substance is dried in a vacuum drying oven at 45-55° C. for 22-26 h;

it indicates that drying at the above temperature can avoid S-nZVI damage caused by excessively high temperatures while ensuring drying efficiency, thereby effectively ensuring the optimizing effect of S-nZVI on nano iron.

Further, in step S1, the centrifuging rate is 5900-6100 rpm, and the centrifuging time is 6-10 min;

it indicates that the sulfur-doped nano iron particles obtained under the above centrifugal condition are more uniform, and has a better optimization effect on the dye-organic wastewater anaerobic co-metabolic system.

Further, in step S1, the mass concentration of the ethanol is 93-97%;

it indicates that the ethanol with the above mass concentration is easy to volatilize and dry on the basis of meeting the effective washing of sulfur-doped nano iron.

Further, in step S2, the dye-organic wastewater comprises the following components: 200 mg/L methyl orange (MO), 2000 mg/L glucose, 25 mg/L KH₂PO₄, 100 mg/L NH₄Cl, 20 mg/L MgCl₂, 30 mg/L CaCl₂, 5 mg/L ethylenediaminetetraacetic acid (EDTA), 2 mg/L FeSO₄·7H₂O, 1 mg/L ZnSO₄·7H₂O, 3 mg/L MnCl₂·4H₂O, 30 mg/L H₃BO₄, 20 mg/L CoCl₂·6H₂O, 1 mg/L CuCl₂·2H₂O, 2 mg/L NiCl₂·6H₂O and 3 mg/LNa₂MoO₄·2H₂O;

it indicates that the main reason for adding glucose in dye-organic wastewater treatment is to provide an additional carbon source, enhance the biodegradability of microorganisms to promote the growth and metabolic activities of microorganisms, thereby improving the efficiency and stability of the entire wastewater treatment system.

Further, in step S2, the rotation speed of the shaker is 140-160 rpm, and the temperature is 36-38° C.;

it indicates that proper low-speed shaking helps maintaining anaerobic conditions and promoting the metabolic activities of anaerobic microorganisms, thereby improving the anaerobic biological treatment effect of samples after nitrogen stripping.

Compared with the existing dye-organic wastewater co-metabolic system, the present disclosure has the beneficial effects:

(1) in the present disclosure, sulfur-doped nano iron is first applied to the dye-organic wastewater anaerobic co-metabolic system, so that by sulfur doping, the dispersibility of nano iron is improved; by sulfur doping, the hydrogen evolution reaction is inhibited, and the reductive damage of cell membranes caused by direct contact between nano iron and microorganisms is avoided, thereby enhancing the biocompatibility of nano iron; meanwhile, the formation of FeS endows nano iron with stronger electrical conductivity, which is conducive to enriching the electron transfer pathways of microorganisms and improving the transfer efficiency of electrons, thereby not only achieving the efficient degradation of dyes, but also effectively overcoming the acid inhibition in the anaerobic digestion process under the dye stress, and the rapid starting of the reactor and methane recovery can be achieved without sludge acclimation.

(2) For dye degradation, the formation of a conductive layer FeS is conducive to improving the extracellular electron transmission capacity of microorganisms, and the degradation of dyes shifts from intracellular to extracellular, which not only avoids the limitation of dye transmembrane transport, but also alleviates the toxic effect caused by pollutants entering cells.

(3) For the anaerobic digestion process, S-nZVI is beneficial for enriching functional microorganisms, providing exogenous electrons, thereby reducing CO₂ to methane, and establishing a direct interspecific electron transfer mechanism; and therefore, VFAs can be efficiently converted into methane even under adverse conditions (dye stress).

### BRIEF DESCRIPTION OF THE DRAWINGS

FIG. 1 is a comparison diagram showing removal of methyl orange (MO) of the present disclosure;

FIG. 2 is a comparison diagram showing accumulation of VFAs in the anaerobic digestion process of the present disclosure;

FIG. 3 is a comparison diagram showing the removal of chemical oxygen demand (COD) of the present disclosure; and

FIG. 4 is a comparison diagram showing methanogenesis in the anaerobic digestion process of the present disclosure.

### DETAILED DESCRIPTION OF THE EMBODIMENTS

To more further demonstrate the methods adopted and effects achieved by the present disclosure, the technical solution of the present disclosure will be clearly and completely described below in conjunction with experiments.

Example 1: A method for rapidly starting a dye-organic wastewater anaerobic co-metabolic system based on S-nZVI comprises the following steps:

### S1, Preparation of S-nZVI

In an inert atmosphere with the purity of 99.5%, sodium dithionite and 0.13 mol/L ferrous sulfate heptahydrate were dissolved into 50 L of ultrapure water in a molar ratio of S:Fe=0.3:1, the above materials were stirred and evenly mixed at 200 rpm to obtain a mixed solution, 0.45 mol/L potassium borohydride was dropwise added into the mixed solution at an addition rate of 10 mL/min by using a peristaltic pump for 20 min for reduction reaction, the obtained reduction product was centrifuged under the condition of 6000 rpm for 8 min, supernatant was removed and the remaining product was washed with ultrapure water and ethanol with the mass concentration of 95% in sequence, the washed product was dried in a vacuum oven at 50° C. for 24 h to obtain sulfur-doped nano iron particles marked as S-nZVI and named S1-0.3; and

### S2, Anaerobic Treatment of S-nZVI Optimized Dye-Organic Wastewater

The anaerobically digested sludge was added into a 250 mL serum bottle with an effective reaction volume of 200 mL and the concentration of the anaerobically digested sludge was adjusted to 5 gTS/L, then the S-nZVI obtained step S1 was added into the anaerobically digested sludge in an addition amount of 0.5 g/L, 150 mL of dye-organic wastewater was introduced into the sludge, the pH was adjusted to 7 by a 0.1 mol/L HCl solution, and then the sludge subjected to nitrogen stripping for 30 min was put onto a shaker for 12 h of anaerobic biological treatment at the rotation speed of 150 rpm at 37° C.

In step S2, the dye-organic wastewater comprised the following components: 200 mg/L methyl orange (MO), 2000 mg/L glucose, 25 mg/L KH₂PO₄, 100 mg/L NH₄Cl, 20 mg/L MgCl₂, 30 mg/L CaCl₂, 5 mg/L EDTA, 2 mg/L FeSO₄·7H₂O, 1 mg/L ZnSO₄·7H₂O, 3 mg/L MnCl₂·4H₂O, 30 mg/L H₃BO₄, 20 mg/L CoCl₂·6H₂O, 1 mg/L CuCl₂·2H₂O, 2 mg/L NiCl₂·6H₂O and 3 mg/L Na₂MoO₄·2H₂O.

Example 2: different from example 1, in step S1, a molar ratio of sodium dithionite and ferrous sulfate heptahydrate was S:Fe=0.1:1, and the obtained product was named S1 −0.1.

Example 3: different from example 1, in step S1, a molar ratio of sodium dithionite and ferrous sulfate heptahydrate was S:Fe=0.5:1, and the obtained product was named S1 −0.5.

Example 4: different from example 1, in step S1, 0.4 mol/L potassium borohydride was dropwise added into the mixed solution at an addition rate of 8 mL/min by using a peristaltic pump for 18 min, the obtained reduction product was centrifuged and then supernatant was removed, the remaining product was washed with ultrapure water and ethanol with the mass concentration of 93% in sequence, and the washed product was dried in vacuum to obtain sulfur-doped nano iron particles.

Example 5: different from example 1, in step S1, 0.5 mol/L potassium borohydride was dropwise added into the mixed solution at an addition rate of 12 mL/min by using a peristaltic pump for 22 min, the obtained reduction product was centrifuged and then supernatant was removed, the remaining product was washed with ultrapure water and ethanol with the mass concentration of 97% in sequence, and the washed product was dried in vacuum to obtain sulfur-doped nano iron particles.

Example 6: different from example 1, in step S1, the purity of the inert atmosphere was 99%, the stirring rotation speed was 180 rpm, and the stirring time was 25 min.

Example 7: different from example 1, in step S1, the purity of the inert atmosphere was 99.9%, the stirring rotation speed was 220 rpm, and the stirring time was 40 min.

Example 8: different from example 1, in step S1, the vacuum drying method was as follows: the washed substance was dried in a vacuum oven at 45° C. for 22 h.

Example 9: different from example 1, in step S1, the vacuum drying method was as follows: the washed substance was dried in a vacuum oven at 55° C. for 26 h.

Example 10: different from example 1, in step S1, the centrifuging rate was 5900 rpm, and the centrifuging time was 6 min.

Example 11: different from example 1, in step S1, the centrifuging rate was 6100 rpm, and the centrifuging time was 10 min.

Example 12: different from example 1, in step S2, the addition amount of S-nZVI was 0.4 g/L, and the concentration of the anaerobically digested sludge was 4 gTS/L.

Example 13: different from example 1, in step S2, the addition amount of S-nZVI was 0.6 g/L, and the concentration of the anaerobically digested sludge was 6 gTS/L.

Example 14: different from example 1, in step S2, the rotation speed of the shaker was 140 rpm, and the temperature was 36° C.

Example 15: different from example 1, in step S2, the rotation speed of the shaker was 160 rpm, and the temperature was 38° C.

Experimental example: the description basis of this experimental example is a scheme described in example 1, aiming to clarify the practical application effect of the present disclosure.

1. Investigation of the effects of compositions of optimized materials and a synthesis method of optimized materials on the rapid starting of a dye-organic wastewater anaerobic co-metabolic system.

Blank group: different from example 1, the optimized materials were not added.

Control group 1: different from example 1, 0.5 g/L sulfur-doped nano iron particles were replaced with nano iron particles and named nZVI. For the synthesis of nano iron, other steps were the same as those for S-nZVI in one-step method except for the addition of sodium dithionite.

Control group 2: different from example 1, S-nZVI was synthesized by using a two-step method. The synthesis method was as follows: 0.13 mol/L ferrous sulfate heptahydrate was dissolved into 50 L of ultrapure water under the stirring condition of 200 rpm at the nitrogen atmosphere of 99.99%, 0.45 mol/L potassium borohydride was slowly added into the above mixed solution at the rotation speed of 10 mL/min by using a peristaltic pump for 20 min, then sodium dithionite was then added for 30 min of reaction, wherein a molar ratio of sodium dithionite to ferrous sulfate heptahydrate was S:Fe=0.3:1, the obtained product was centrifuged for 8 min at 6000 rpm, supernatant was removed, the remaining product was washed with ultrapure water and ethanol with the concentration of 95% in sequence, and then the washed product was dried in a vacuum oven at 50° C. for 24 h to obtain sulfur-doped nano iron particles named S2 −03;

Control group 3: different from control group 2, the molar ratio of sodium dithionite to ferrous sulfate heptahydrate was S:Fe=0.1:1, named S2 −0.1.

Control group 4: different from control group 2, the molar ratio of sodium dithionite to ferrous sulfate heptahydrate was S:Fe=0.5:1, named S2 −0.5.

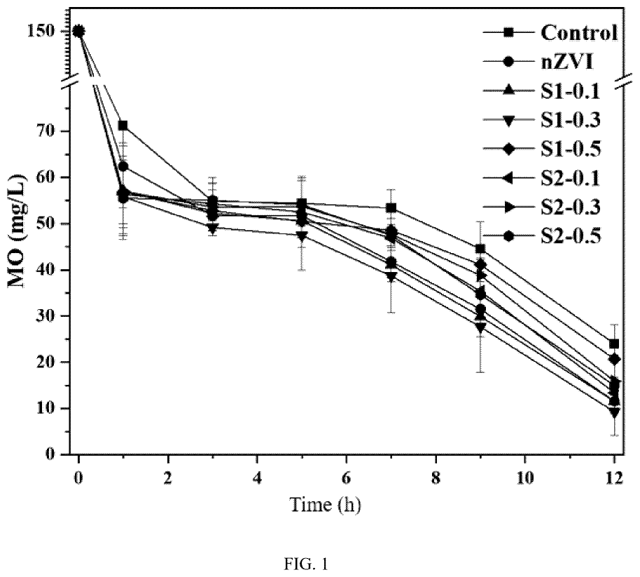

Conclusion: the test results are as shown in figures. As shown in FIG. 1, at 12 h after the start of the reaction, the dye removal rate of each group reached more than 80%, wherein the dye removal rate of S1 −0.3 was higher than that in other groups and reached 93.82%.

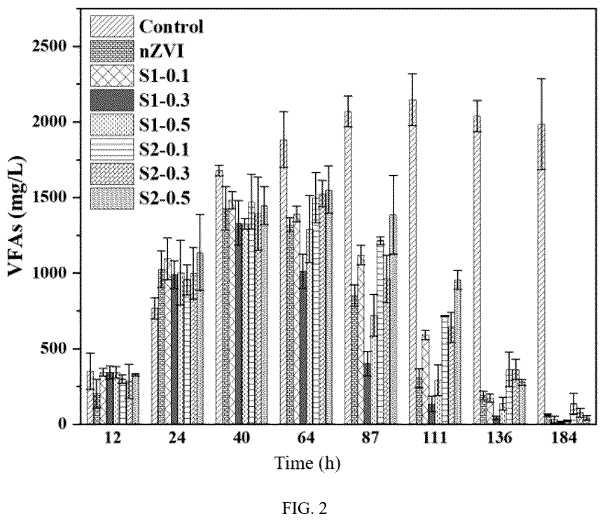

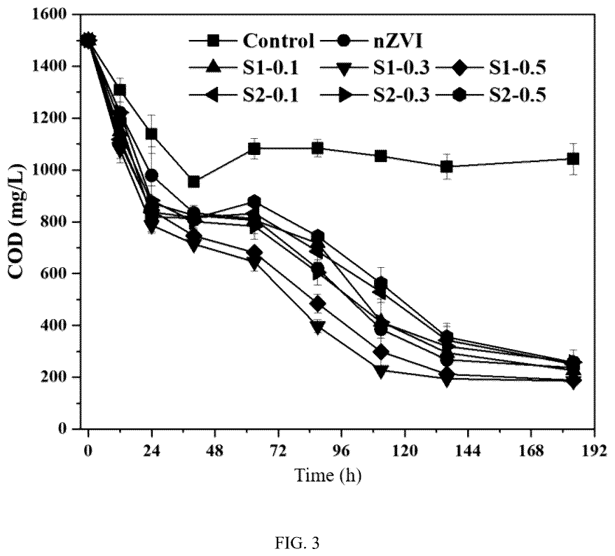

For the anaerobic digestion process, during the 184 h operation period, the blank group exhibited obvious and irreversible acid accumulation due to dye stress. This also significantly inhibited both COD degradation and methanogenesis, thereby allowing the anaerobic digestion process not to smoothly proceed. In control groups 1-4 and examples 1-3, the addition of materials effectively alleviated acid inhibition. As shown in FIG. 2, after the anaerobic digestion was ended, the VFAs in material groups reached below 100 mg/L. Furthermore, as can be seen from FIG. 3, the COD removal rates of control groups 1-4 and example groups 1-3 were all more than 80%.

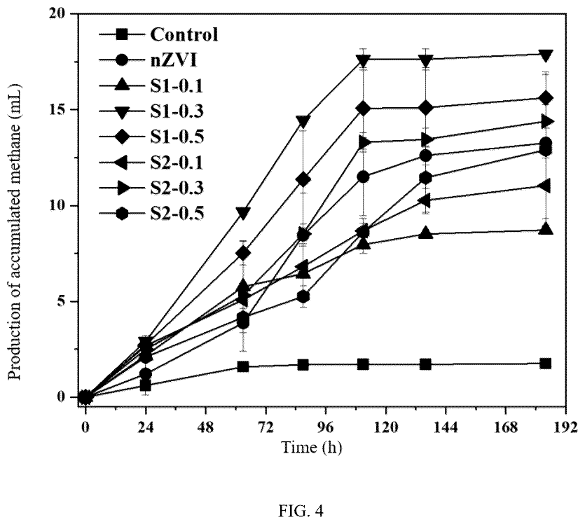

As can be seen from FIG. 4, except for blank group, the production of accumulated methane in each of other groups gradually increased, and the irreversible acid accumulation in blank group affected COD degradation and methanogenesis, indicating that the addition of the nano iron materials achieved the smooth starting of the methanogenesis process; it can be seen from control example 1 and control examples 2-4 that sulfur doping further promoted the methanogenesis. Furthermore, the S1 −0.3, S1 −0.5 and S2 −0.3 obtained from example 1, example 3 and control group 1 increased by 35.07%, 17.72% and 8.52% compared with that obtained from nZVI group. Therefore, in the dye-organic wastewater anaerobic co-metabolic system, S-nZVI, which is synthesized in one-step method, has S/Fe of 0.3 and is prepared in example 1, has absolute advantages in promoting dye degradation, alleviating acid inhibition and improving methanogenesis efficiency.

2. Investigation of the effects of each parameter of S-nZVI preparation and S-nZVI optimized dye-organic wastewater during the anaerobic treatment under the 184 h operating state on COD removal rate and methane production

TABLE 1
Effects of treatment methods in example 1 and examples 4-15 on COD removal rate and methane yield

| | Example | Example | Example | Example | Example | Example | Example |
|---|---|---|---|---|---|---|---|
| Group | 1 | 4 | 5 | 6 | 7 | 8 | 9 |
| COD removal rate % | 80.3 | 80 | 79.6 | 79.9 | 79.5 | 79.2 | 80.1 |
| Methane production mL | 18.6 | 18 | 17.8 | 18.2 | 17.9 | 18.2 | 18 |

| | Example | Example | Example | Example | Example | Example |
|---|---|---|---|---|---|---|
| Group | 10 | 11 | 12 | 13 | 14 | 15 |
| COD removal rate % | 79.3 | 79.9 | 79.5 | 80.2 | 78.8 | 79.6 |
| Methane production mL | 18.4 | 18.1 | 18.2 | 17.9 | 18.6 | 18.2 |

Conclusion: it can be seen by comparing example 1 and examples 4-15 that, within the range defined in the present application, anaerobic treatment is performed on dye-organic wastewater under the 184 h operating state by using too-low or too-high potassium borohydride addition parameters, inert atmosphere purity, stirring parameters, drying temperature and centrifuging parameters, the achieved COD removal effect and methane efficacy show little difference from those in example 1. Therefore, from an economic perspective, example 1 is selected as an optimal solution.

1. A method for rapidly starting a dye-organic wastewater anaerobic co-metabolic system based on S-nZVI, comprising the following steps:
S1, preparation of S-nZVI
in an inert atmosphere, dissolving sodium dithionite and 0.1-0.15 mol/L ferrous sulfate heptahydrate in ultrapure water in a molar ratio of S:Fe=(0.1-0.5):1, stirring and evenly mixing to obtain a mixed solution, dropwise adding 0.4-0.5 mol/L potassium borohydride into the mixed solution at an addition rate of 8-12 mL/min by using a peristaltic pump for 18-22 min, removing supernatant followed by centrifuging and washing the obtained product with ultrapure water and ethanol in sequence, and subsequently performing vacuum drying on the washed product to obtain sulfur-doped nano iron particles marked as S-nZVI; and
S2, anaerobic treatment of S-nZVI optimized dye-organic wastewater
adding anaerobically digested sludge into a serum bottle and allowing the concentration of the anaerobically digested sludge to 4-6 gTS/L, then adding the S-nZVI obtained step S1 into the anaerobically digested sludge in an addition amount of 0.4-0.6 g/L, introducing 120-180 mL of dye-organic wastewater into the sludge, adjusting the pH of the sludge to 6.8-7.2 by using a pH adjuster, and then putting the sludge subjected to nitrogen stripping for 25-35 min onto a shaker for 10-14 h of anaerobic biological treatment;
wherein, in step S2, the dye-organic wastewater comprises the following components: 200 mg/L methyl orange (MO), 2000 mg/L glucose, 25 mg/L KH₂PO₄, 100 mg/L NH₄Cl, 20 mg/L MgCl₂, 30 mg/L CaCl₂, 5 mg/LEDTA, 2 mg/L FeSO₄·7H₂O, 1 mg/L ZnSO₄·7H₂O, 3 mg/L MnCl₂·4H₂O, 30 mg/L H₃BO₄, 20 mg/L CoCl₂·6H₂O, 1 mg/L CuCl₂·2H₂O, 2 mg/L NiCl₂·6H₂O and 3 mg/L Na₂MoO₄·2H₂O.

2. The method for rapidly starting a dye-organic wastewater anaerobic co-metabolic system based on S-nZVI according to claim 1, wherein in step S1, the purity of the inert gas is 99-99.9%, the stirring speed is 180-220 rpm, and the stirring time is 25-40 min.

3. The method for rapidly starting a dye-organic wastewater anaerobic co-metabolic system based on S-nZVI according to claim 1, wherein the vacuum drying method is as follows: the washed substance is dried in a vacuum drying oven at 45-55° C. for 22-26 h.

4. The method for rapidly starting a dye-organic wastewater anaerobic co-metabolic system based on S-nZVI according to claim 1, wherein in step S1, the centrifuging rate is 5900-6100 rpm, and the centrifuging time is 6-10 min.

5. The method for rapidly starting a dye-organic wastewater anaerobic co-metabolic system based on S-nZVI according to claim 1, wherein in step S1, the mass concentration of the ethanol is 93-97%.

6. The method for rapidly starting a dye-organic wastewater anaerobic co-metabolic system based on S-nZVI according to claim 1, wherein in step S2, the rotation speed of the shaker is 140-160 rpm, and the temperature is 36-38° C.
